(19) United States
(12) Patent Application Publication
(10) Pub. No.: US 2009/0327030 A1
(43) Pub. Date: Dec. 31, 2009

(54) Systems and Methods for Creating an Index to Measure a Performance of Digital Ads as Defined by an Advertiser

(75) Inventor: Robert Collins, Brookfield, NH (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/146,241

(22) Filed: Jun. 25, 2008

(51) Int. Cl. G06Q 10/00

(52) U.S. Cl. 705/10

(57) ABSTRACT

Systems and methods for utilizing a performance index measuring a performance of an object as defined by an advertiser are disclosed. Generally, an ad campaign optimizer receives one or more values associated with events that result from marketing activities associated with one or more objects. The ad campaign optimizer calculates a performance index associated with an object of the one or more objects, wherein the performance index measures a performance of the object based on the received one or more values. The ad campaign optimizer then optimizes a digital ad based on the calculated performance index.

### BACKGROUND

Online advertising allows an advertiser to display digital ads related to goods and/or services to an Internet user when the Internet user performs actions such as visiting a webpage or submitting a search query to an Internet search engine. Typically, an online advertisement service provider (“ad provider”) serves digital ads to an Internet user based on factors such as terms within a search query submitted by the Internet user to an Internet search engine, terms within the content of a webpage visited by the Internet user, and a bid amount associated with a digital ad.

The bid amount is an amount of money that the advertiser agrees to pay the advertiser based on specific billing events associated with a digital ad. Examples of billing events include an impression of a digital ad, an Internet user clicking on a digital ad, and a conversion associated with a digital ad. Once an ad provider identifies a set of candidate digital ads that may be served to an Internet user in response to actions such as the Internet user visiting a webpage or submitting a search query, the ad provider determines which digital ads of the set of candidate digital ads to serve, and a position on a webpage to display the served digital ads, based on the bid amount associated with a digital ad. Generally, digital ads associated with higher bid amounts are served before digital ads associated with lower bid amounts, and the higher a bid amount associated with a digital ad, the more prominent the digital ad is displayed on a webpage.

Because of the high level of competition between advertisers to have the ad provider serve their advertisements, advertisers are often adjusting the bid amounts associated with their digital ads. In order to assist advertisers in setting or adjusting bid amounts associated with their digital ads, ad providers or other third parties often provide ad campaign optimizers that automatically adjust bid amounts associated with digital ads of an advertiser based on business objects of the advertiser.

### BRIEF DESCRIPTION OF THE DRAWINGS

FIG. 1 is a block diagram of an environment in which a system for creating an index to measure a performance of digital ads as defined by an advertiser may operate;

FIG. 2 is a block diagram of a system for generating one or more media plans for the delivery of one or more digital ads;

FIG. 3 is a diagram of a value funnel;

FIG. 4 is a flow diagram of a method for selecting digital ads based on a budget for inclusion in a media plan;

FIG. 5 is a flow diagram of a method for executing and monitoring a media plan for one or more digital ads in a given advertisers budget;

FIG. 6 is a block diagram of a system for optimizing digital ads;

FIG. 7 is a flow diagram of a method for optimizing digital ads;

FIG. 8 is a flow diagram of a method for optimizing a delivery of digital ads;

FIG. 9 is a flow diagram of another method for optimizing the delivery of digital ads;

FIG. 10 is a flow diagram of another method for optimizing the delivery of digital ads;

FIG. 11 is a flow diagram of a method for randomly selecting a digital ad in response to request utilizing weights associated with digital ads; and

FIG. 12 is a flow diagram of a method for creating an index to measure a performance of digital ads as defined by an advertiser.

### DETAILED DESCRIPTION OF THE DRAWINGS

The present disclosure is directed to systems and methods for creating an index to measure a performance of digital ads as defined by an advertiser. Ad campaign optimizers, such as those disclosed in U.S. patent application Ser. No. 11/321,729, filed Dec. 28, 2005, and U.S. patent application Ser. No. 11/321,888, filed Dec. 28, 2005, both of which are assigned to Yahoo! Inc., allow advertisers to define how their digital ads are optimized. For example, an advertiser may choose a value to associate with marking events such as impressions, click-throughs (visitors to a website), conversions, and revenue associated with conversions. As explained in more detail below, to provide advertisers with a tool for judging the performance of digital ads, the ad campaign optimizer generates a performance index measuring a performance of digital ads as defined by the advertiser.

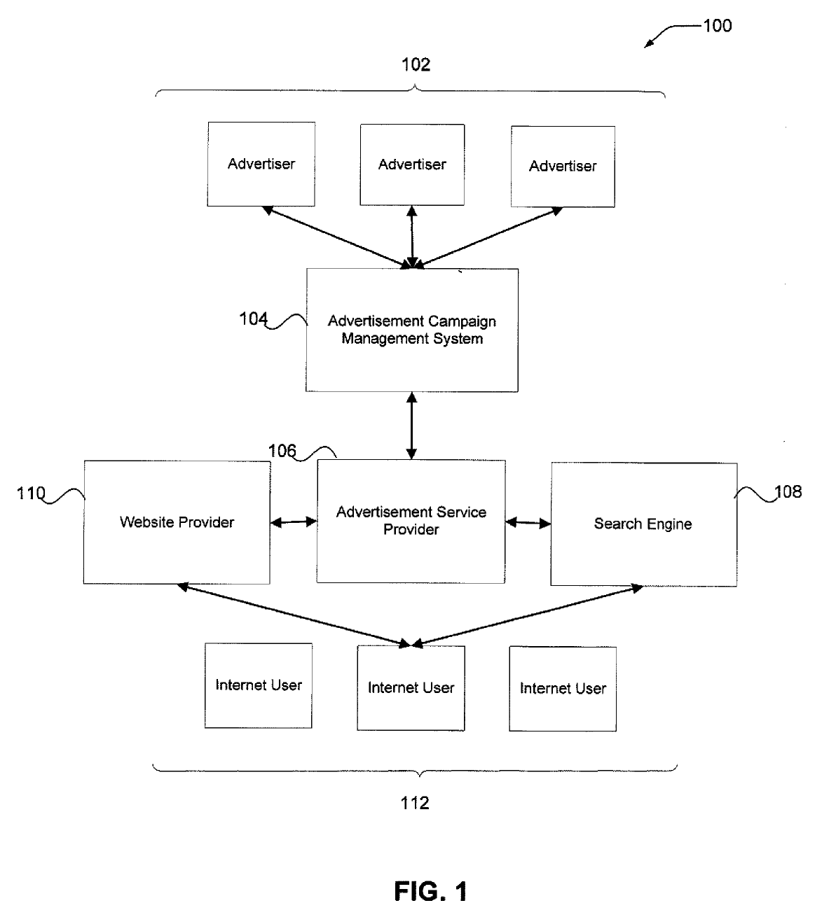

FIG. 1 is a block diagram of an environment in which a system for creating an index to measure a performance of digital ads as defined by an advertiser may operate. The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by an Internet user 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the search engine 1 08 typically receives a search query comprising one or more keywords. In response to the search query, the search engine 108 returns search results including one or more search listings based on keywords within the search query provided by the Internet user 112. Additionally, the ad provider 106 may receive a digital ad request based on the received search query. In response to the digital ad request, the ad provider 106 serves one or more digital ads created using the ad campaign management system 104 to the search engine 108 and/or the Internet user 112 based on keywords within the search query provided by the Internet user 112.

Similarly, when an Internet user 112 requests a webpage served by the website provider 110, the ad provider 106 may receive a digital ad request. The digital ad request may include data such as keywords obtained from the content of the webpage. In response to the digital ad request, the ad provider 106 serves one or more digital ads created using the ad campaign management system 104 to the website provider 110 and/or the Internet user 112 based on the keywords within the digital ad request.

When the digital ads are served, the ad campaign management system 104 and/or the ad provider 106 may record and process information associated with the served digital ads for purposes such as billing, reporting, or ad campaign optimization. For example, the ad campaign management system 104 and/or the ad provider 106 may record the factors that caused the ad provider 106 to select the served digital ads; whether the Internet user 112 clicked on a URL or other link associated with one of the served digital ads; what additional search listings or digital ads were served with each served digital ad; a position on a webpage of a digital ad when the Internet user 112 clicked on a digital ad; and/or whether the Internet user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. Additionally, ad campaign optimizers that may optimize digital ads based on the type of information discussed above are disclosed in U.S. patent application Ser. No. 11/321,729, filed Dec. 28, 2005, and U.S. patent application Ser. No. 11/321,888, filed Dec. 28, 2005, both of which are assigned to Yahoo! Inc., the entirety of each of which is hereby incorporated by reference.

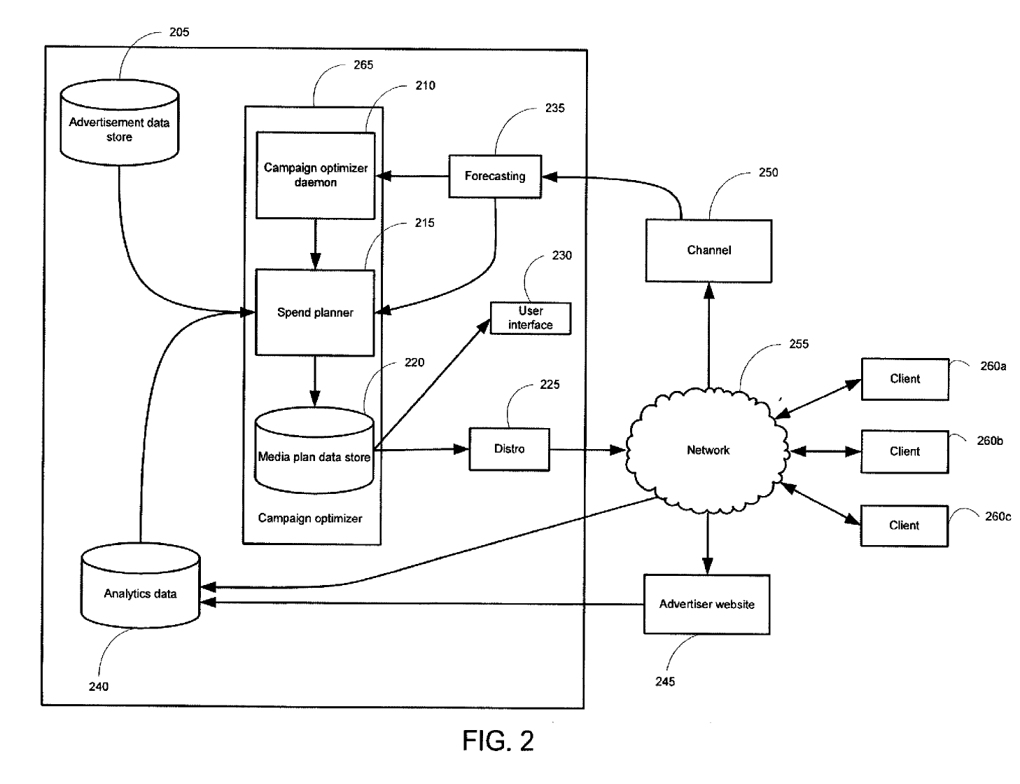

FIG. 2 is a block diagram of a system for generating one or more media plans for the delivery of one or more digital ads, also known as an ad campaign optimizer. Generally, one or more ad campaigns comprising one or more digital ads are stored in an ad data store 205. Ad campaigns may include sponsored search listings or links to an advertiser's webpage.

A budget associated with the one or more ad campaigns may be stored in the ad data store 205. A budget comprises an indication of the maximum dollar value a given advertiser has available to spend on the one or more digital ads in an advertiser's one or more ad campaigns.

In addition to budget information, the ad data store 205 may also contain targets and constraints, which may be generally described as performance goals and restrictions upon advertising, respectively. For example, a constraint may comprise a limit upon a bid amount in an auction-based system or marketplace for advertising. A marketplace may be used to place bids on search terms or groups of terms that when used in a search query cause the display of an advertiser's digital ads or links to digital ads among the displayed results. Bids may also be made to secure prominence and positions for an advertiser's one or more digital ads in response to a given search query. For example, an advertiser may desire to display a given digital ad or group of digital ads in response to one or more terms and may further desire to display the digital ads in a particular position of a result set that a search engine returns. Through the use of a marketplace or auction-based system, bids may be placed on the one or more terms corresponding to the digital ads the advertiser wishes to display. The advertisers with the greatest bids for one or more keywords may have their digital ads displayed in the most prominent positions of a given result set of digital ads.

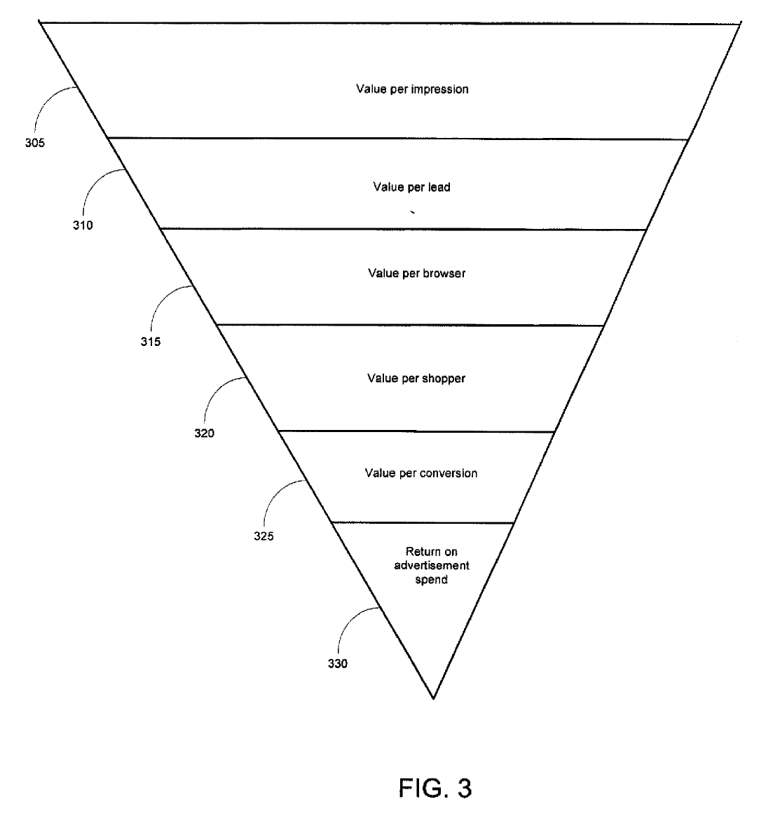

A target may comprise an indication of the cost per acquisition (“CPA”) or return on advertisement spend (“ROAS”) for a given digital ad. Cost per acquisition generally relates to an advertiser's cost for a given advertising event or metric. Advertising events or metrics include, but are not limited to, impressions, leads, browsers, shoppers and conversions, where impressions comprise the display of one or more digital ads, leads comprise selection of one or more digital ads by an Internet user, browsers comprise Internet users accessing one or more webpages of an advertiser's website associated with a given advertiser's products or services, shoppers comprise Internet users who add products to a shopping cart displayed by a given digital ad, and conversions comprise purchases of products advertised by a digital ad selected by an Internet user. For example, if a given digital ad resulted in two hundred purchases, and the advertisement cost an advertiser is one thousand dollars to display a digital ad, the advertiser's cost per acquisition for conversions would equal five dollars. Similarly, if a given advertisement cost an advertiser is one hundred dollars to display a digital ad and the digital ad was selected five thousand times, the advertiser's cost per acquisition for leads would equal two cents. According to methods described herein, an advertiser may specify the cost per acquisition for one or more advertising events or metrics according to a value funnel, as illustrated in FIG. 3.

Return on advertisement spend (ROAS) generally comprises the revenue earned on one or more digital ads displayed to Internet users. Advertisers may have a plurality of digital ads to display to Internet users of client devices in response to various search requests. Furthermore, advertisers may pay a fee for displaying digital ads in response to various search requests. While an advertiser may display a plurality of digital ads directed at various products offered by the advertiser, only a few of the digital ads displayed result in actual purchases. An advertiser may want to ensure that the amount of money earned on purchases exceeds the amount of money spent on advertising. According to methods described herein, an advertiser may specify the return on advertisement spend for one or more digital ads.

In one implementation, an advertiser may specify a maximum bid constraint for storage in the ad data store 205. A maximum bid constraint may comprise an indication of the greatest dollar value an advertiser is willing to spend on any one or more digital ad in one or more ad campaigns. An advertiser may also specify a maximum bid constraint for one or more individual digital ads, specify a maximum bid constraint for all digital ads in a given ad campaign, or specify a maximum bid constraint for all digital ads in a given budget.

An advertiser may also specify a target minimum position. A target minimum position may comprise an indication of the lowest allowable ranking at which one or more digital ads may be displayed in a ranked list of digital ads. For example, an advertiser may indicate a desire to have one or more digital ads ranked either first, second or third in a ranked list of digital ads. Therefore, the advertiser may define a target minimum position of three (3). An advertiser may also specify a target minimum position for one or more individual digital ads, specify a target minimum position for all digital ads in a given ad campaign, or specify a target minimum position for all digital ads in a given budget.

An advertiser may also specify the values for one or more advertising events or metrics in a value funnel (illustrated in FIG. 3). For example, an advertiser may specify values associated with impressions, leads, browsers, shoppers, conversions and/or return on advertisement spend. The one or more values specified by an advertiser are stored in the ad data store 205 with associated digital ads or ad campaigns. The values allow an advertiser to indicate the value of one or more advertising events or metrics for the one or more digital ads in a given budget.

The analytics data store 240 is operative to store click through data for the one or more digital ads stored in the ad data store 205. In one implementation, the analytics data store 240 maintains data on a number of times a given digital ad was selected, a time at which a given digital ad was displayed, and user characteristics of a given Internet user that selected a given digital ad, e.g., by reference to a profile for the given Internet user.

In some implementations, the analytics data store 240 maintains data pertaining to one or more keywords submitted by Internet users of client devices 260a, 260b and 260c. For example, the analytics data store 240 may maintain information indicating a cost for displaying a digital ad in response to a given user search query. In other implementations, the analytics data store 240 maintains data on the one or more values in a value funnel for one or more digital ads.

The analytics data store 240 is an accessible memory structure such as a database, CD-ROM, tape, digital storage library, etc., and may be implemented as a database or any other type of data storage structure capable of providing for the retrieval and storage of a variety of data types. The analytics data store 240 may also store a variety of data related to digital ads. Information in the analytics data store 240 may be maintained in ad groups according to advertiser, product, category, keywords, funnel values or a combination thereof.

One or more digital ads, constraints targets, funnel values and budget information for an advertiser are delivered to a spend planner component 215. The spend planner component 215 is operative to generate one or more execution plans identifying the one or more execution parameters for one or more digital ads in a given advertiser's budget. In some implementations, the execution parameters of an execution plan identified by the spend planner component 215 are based upon one or more aspects of a digital ad that a channel 250 allows to be varied. For example, Yahoo! may allow an advertiser to vary the bid associated with the keywords for displaying a given digital ad or whether a given digital ad is online or offline. The execution parameters of the one or more execution plans identified by the spend planner component 215 may alter whether the one or more digital ads in a given advertiser's budget are online or offline while also altering the bid amount associated with the one or more digital ads in a given advertiser's budget.

The one or more execution parameters of a given execution plan that the spend planner component 215 generates may also be based upon the one or more advertiser specified advertisement constraints. For example, as previously described, an advertiser may set a maximum bid constraint on one or more digital ads in a given advertiser's budget. The execution parameters that the spend planner component 215 generates for a given execution plan respect the advertiser's constraints and do not identify bid execution parameters that violate a given advertiser's one or more bid constraints.

The one or more execution parameters for a given execution plan generated by the spend planner component 215 are annotated with forecast data from a forecasting component 235. In some implementations, the spend planner component 215 delivers one or more keywords associated with displaying one or more digital ads in a given advertiser's budget to the forecasting component 235. The forecasting component 235 is operative to retrieve information regarding the one or more digital ads displayed in response to the one or more keywords delivered to the forecasting component 235.

The forecasting component 235 retrieves information for the one or more digital ads based upon one or more steps in a value funnel, as well as the bid associated with a given digital ad and its position in a ranked list of digital ads. For example, the spend planner component 215 may deliver the keywords “notebook computer” to a forecasting component 230. The forecasting component 230 may retrieve historical information regarding the one or more digital ads displayed in response to the keywords “notebook computer,” the bids associated with the one or more digital ads, as well as the position of the one or more digital ads in a ranked list of digital ads.

The forecasting component 235 may further be operative to retrieve historical data regarding the one or more digital ads displayed in response to the keywords “notebook computer” based upon the one or more steps in the value funnel. For example, the forecasting component 235 may retrieve historical data indicating that a given digital ad received two hundred impressions, eighty leads, forty browsers, eight shoppers and four conversions. The forecast component 235 may retrieve historical data from the analytics data store 240 indicating the number and type of advertising events obtained at various bid amounts for one or more keywords, as well as the position of one or more digital ads in a ranked list of digital ads displayed in response to the given keywords. In some implementations, the forecast component 235 calculates the average number of advertising events obtained at various bid amounts for the one or more digital ads displayed in response to one or more keywords to provide a forecast of the expected number of advertising events that may be obtained at various bid amounts.

The various execution parameters generated by the spend planner component 215 for a given execution plan are annotated by the spend planner component 215 with the forecast data from the forecasting component 235. For example, the execution parameters for a given execution plan may identify various bid amounts associated with the one or more digital ads in the execution plan. The forecast data as obtained from the forecasting component 235 may be used to annotate the execution parameters at each respective bid amount and may indicate the varying levels of funnel values (as illustrated in FIG. 3) that are obtained at varying bid amounts. In some implementations, the forecast data may indicate the number of impressions, leads, browsers, shoppers and conversions obtained at one or more bid amounts. Table A illustrates an exemplary execution plan wherein digital ads are annotated with forecasting information from the forecasting component 235.

TABLE A

| | | | Average |
|---|---|---|---|
| | | | Forecast Value at |
| | | | Bid Amount and |
| Advertisement | Bid Amount | Average Position | Position |
| A1 | $2.50 | 7 | Impressions: 200 |
| | | | Leads: 120 |
| | | | Browsers: 40 |
| | | | Shoppers 18 |
| | | | Conversions: 2 |
| A2 | $1.50 | 5 | Impressions: 300 |
| | | | Leads: 320 |
| | | | Browsers: 60 |
| | | | Shoppers 28 |
| | | | Conversions: 4 |
| A3 | $2.00 | 3 | Impressions: 500 |
| | | | Leads: 420 |
| | | | Browsers: 92 |
| | | | Shoppers: 42 |
| | | | Conversions: 12 |

The one or more execution parameters annotated with forecast data may be further annotated with advertisement specific analytics data stored in the analytics data store 240. In some implementations, the analytics data store 240 maintains information identifying the various advertising events associated with a given digital ad. For example, the analytics data store 240 may indicate that a given digital ad displayed in response to the keywords “notebook computer” resulted in forty user selections and twelve purchases with an associated bid of $4. The forecast data obtained from the forecasting component 235, however, may indicate that the average digital ad displayed in response to the term “notebook computer” at a bid of $4 resulted in three hundred user selections and four purchases. Therefore, the execution parameters for the one or more digital ads in a given advertiser's budget are annotated with advertisement specific analytics data to provide a more accurate prediction of the number of advertising events a given digital ad obtains when displayed in response to a given one or more keywords at a given bid amount.

The spend planner component 215 uses the annotated execution parameters of the one or more execution plans, as well as a given advertiser's budget, constraints and funnel values to generate one or more media plans. A media plan generated by the spend planner component 215 identifies the optimal execution parameters used in conjunction with a given set of digital ads in an advertiser's budget. In some implementations, a media plan identifies the optimal bid amounts for the digital ad in a given advertiser's budget.

The spend planner component 215 generates one or more media plans with execution parameters that do not exceed the one or more constraints associated with a given budget. As previously described, a budget may specify the maximum dollar value an advertiser is willing to spend on one or more digital ads in one or more ad campaigns. The spend planner component 215 is operative to formulate one or more media plans that apportion a given advertiser's budget, ensuring that a given budget is not exceeded. In some implementations, the spend planner component 215 attempts to utilize all available funds in a given advertisers budget.

The spend planner component 215 uses a scoring function to calculate an efficiency value for the one or more digital ads in a given advertiser's budget. The efficiency values associated with the one or more digital ads in a given budget are used to select digital ads to be included in a given media plan. In some implementations, the scoring function utilizes the forecasted funnel values, the advertisement specific analytics data, and the advertiser specified funnel values to calculate the efficiency of a given digital ad. In some implementations, the one or more digital ads in a given advertisers budget are sorted in descending order by efficiency value. Digital ads with the greatest efficiency values are selected for inclusion in a given media plan until exhaustion of an advertiser's budget. The cost associated with a given digital ad is an emergent property based upon the efficiency value as calculated by the scoring function. The scoring function determines the bid value associated with a given digital ad based upon the calculated efficiency of the digital ad without exceeding a given advertiser's constraints. Various bid amounts are analyzed to determine the bid amount that produces the greatest efficiency for a given digital ad.

The one or more media plans generated by the spend planner component may be stored in the media plan data store 220. In some implementations, each media plan has a set of associated attributes. The attributes associated with a media plan may include, but are not limited to, a name, the budget of the ad campaign or ad campaigns for which the media plan was generated and a date, which may indicate the period of time a media plan is to be executed.

Media plans generated by the spend planner component 215 and stored in the media plan data store 220 may be viewed by advertisers through the user interface 230. In some implementations, an advertiser may select a media plan from the media plan data store 220 for execution. However, in other implementations, the spend planner component 215 selects a media plan from the media plan data store 220 for execution. In some implementations, the user interface 230 provides an advertiser with the ability to examine the projected outcome of a given media plan without actually executing the media plan. The execution parameters for a given media plan, with annotated forecast values, allow an advertiser to view the projected outcome of the media plan with respect to the one or steps of the value funnel. An advertiser may utilize the user interface 230 to increase or decrease the budget associated with one or more digital ads stored in the ad data store 205 to determine how the increase or decrease in budget will affect the performance and outcome of one or more digital ads.

A media plan selected for execution either by an advertiser using the user interface 230 or by the spend planner component 215, is delivered to the distribution component 225. A distribution component 225 is operative to deliver the one or more digital ads and bid execution parameters of a media plan to one or more channels 250. A channel 250, such as Yahoo.com, may be operative to receive one or more digital ads and associated bids and distribute one or more digital ads according to the bids associated with the one or more digital ads. Users of client devices 260a, 260b and 260c communicatively coupled to a network 255 may select one or more of the digital ads displayed by a given channel 250 as part of a webpage. If an Internet user of a client device 260a, 260b and 260c selects a digital ad displayed on a given webpage, the Internet user may be redirected to an advertiser's web site 245. Users interactions with a digital ad and webpage are tracked and may be delivered to the analytics data store 240.

An ad campaign optimizer daemon 210 is operative to invoke the spend planner component 215 to generate one or more media plans. In some implementations, the ad campaign optimizer daemon 210 invokes the spend planner component 215 when a given advertiser adds or deletes one or more digital ads from the ad data store 205. In yet other implementations, the ad campaign optimizer daemon 210 invokes the spend planner component 215 when an advertiser modifies one or more constraints or targets, or updates an existing budget.

In other implementations, the campaign optimizer daemon 210 invokes the spend planner component 215 upon receipt of an alert from the forecasting component 235 indicating a recent deviation in the frequency of search requests for one or more keywords submitted by Internet users of client devices 260a, 260b and 260c to one or more channels 250. The forecast component may be operative to monitor one or more channels 250, such as the Yahoo! search engine. The forecasting component 235 may identify significant deviations in search requests for one or more keywords made by Internet users of client devices 260a, 260b and 260c and alert the ad campaign optimizer daemon 210 of such deviations.

In some implementations, the ad campaign optimizer daemon 210 invokes the spend planner component 215 at regular intervals, which may be predetermined. Alternatively, or in conjunction with the foregoing, the ad campaign optimizer daemon 210 invokes the spend planner component 215 when a given media plan is nearing expiration or has expired. For example, a given media plan may execute for a period of twenty-four hours. The ad campaign optimizer daemon 210 may notify the spend planner component 215 at a given time interval before a given media plan is expiring that a new media plan must be generated.

FIG. 3 illustrates a value funnel data structure, wherein a value funnel comprises the one or more advertising events or metrics that may be associated with one or more digital ads. According to the value funnel illustrated in FIG. 3, an advertiser may specify the value per impression 305 for one or more digital ads, wherein an impression 305 comprises displaying a digital ad in response to a given request. For example, a given ad campaign C1 for advertising a given advertiser's computer products may be comprised of digital ads A1, A2, A3 . . . AN. Digital ad A1 may be an advertisement for notebook computers whereas digital ad A2 may be an advertisement for mouse pads. An advertiser may specify that the value per impression for displaying digital ad A1 in response to the keywords “notebook computer” is fifty cents, whereas the value per impression for displaying digital ad A2 in response to the keywords “mouse pads” is ten cents. An advertiser may specify the value per impression for one or more digital ads. Alternatively, an advertiser may specify the value per impression for all digital ads in a given ad campaign, group of digital ads (also known as an ad group), or digital ads in an advertiser's budget.

According to the value funnel illustrated in FIG. 3, an advertiser may also specify the value per lead 310 for one or more digital ads, which may comprise the value of an Internet user selecting a given digital ad displayed in response to a given request. For example, an advertiser may have various digital ads directed at selling computer products, including mouse pads, Ethernet cords, wireless routers, hard drives, etc. With reference to the abovementioned ad campaign C1, an advertiser may specify that the value per lead for an Internet user selecting digital ad A1 directed at selling Ethernet cords is fifty cents, whereas the value per lead for an Internet user selecting digital ad A2 directed at selling hard drives is four dollars. The advertiser may specify that the value per lead associated with an Internet user selecting digital ad A2 for hard drives is greater than the value per lead associated with an Internet user selecting digital ad A1 for an Ethernet cord since the purchase of a hard drive may result in greater profit for the advertiser. Those of skill in the art recognize other permutations are possible.

An advertiser may also specify a value per browser 315 for one or more digital ads, which may include a value associated with an Internet user selecting a given digital ad and accessing one or more webpages of a given advertiser's website associated with a given advertiser's products or services. With reference to the abovementioned ad campaign C1, an advertiser may specify that the value of a user selecting digital ad A1 and browsing the products associated with digital ad A1 is four dollars, whereas the value of an Internet user selecting digital ad A2 and browsing the products associated with digital ad A2 is two dollars. An advertiser may specify the value per browser for one or more digital ads. Alternatively, an advertiser may specify the value per browser for all digital ads in a given ad campaign or all digital ads in an advertiser's budget.

An advertiser may also specify a value per shopper 320 for one or more digital ads, which may comprise the value associated with an Internet user selecting a given digital ad, accessing a given advertiser's webpage, and adding one or more of an advertiser's products to a shopping cart on the advertiser's webpage. With reference to the abovementioned ad campaign C1, an advertiser may specify that the value of an Internet user selecting digital ad A1 and adding one or more items associated with digital ad A1 to a shopping cart on the advertiser's web site is six dollars, whereas the value of a user selecting digital ad A2 and adding one or more items associated with digital ad A2 is three dollars. An advertiser may specify the value per shopper for one or more digital ads. Alternatively, an advertiser may specify the value per shopper for all digital ads in a given ad campaign or all digital ads in an advertiser's budget.

Similarly, an advertiser may specify a value per conversion 325 for one or more digital ads, which may include a value associated with an Internet user purchasing a product or service displayed by a given digital ad. An advertiser's one or more digital ads may be directed at products that result in varying levels of revenue for the advertiser. For example, the revenue earned by a car dealer on the sale of a new car may be significantly greater than the revenue earned on the sale of a used car. An advertiser with one or more digital ads for new cars and one or more digital ads for used cars may specify that the value per conversion associated with an Internet user purchasing a new car is greater than the value per conversion associated with an Internet user purchasing a used car.

As shown in FIG. 3, an advertiser may also specify the return on advertisement spend (ROAS) 230, wherein return on advertisement spend 230 comprises an indication of the revenue earned on a given digital ad. For example, an advertiser may spend one dollar each time a given digital ad for a notebook computer is selected by an Internet user. If the digital ad is selected four hundred times, the advertiser will spend a total of four hundred dollars on the digital ad. If every four hundred user selections results in a purchase of $1200, the advertiser's return on advertisement spend is the amount the advertiser earns on a given purchase ($1200), minus the amount the advertiser spent on the digital ad ($400), resulting in a return on advertisement spend of $800. Tracking codes inserted in a given digital ad and HTML tags inserted in a given advertiser's webpage may be used to facilitate the identification of the return on advertisement spend. Those of skill in the art recognize that a value funnel may comprise one or more other advertising events or metrics and associated values that may be used to monitor the performance of a given digital ad.

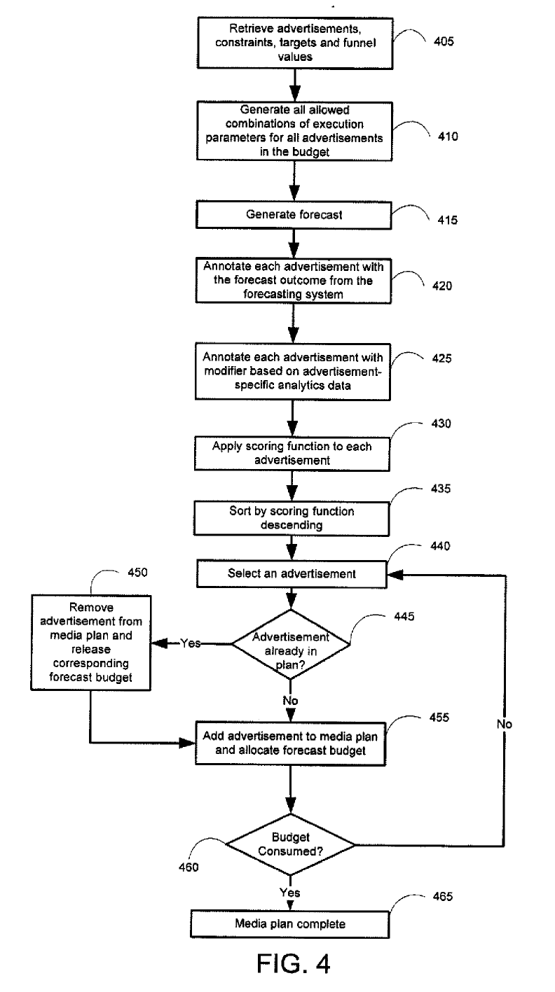

FIG. 4 is a flow diagram of a method for selecting digital ads from a budget for inclusion in a media plan. One or more digital ads in a given advertiser's budget, as well associated constraint and target information are retrieved, step 405. One or more execution plans are generated, where a given execution plan identifies allowed combinations of execution parameters for the retrieved digital ads based upon the advertiser specified target and constraint information, step 410. For example, an advertiser may specify that a digital ad displayed in response to the term “notebook computer” is to be displayed in position one or two of a ranked list of digital ads. An advertiser may further specify that the maximum bid for the term “notebook computer” is three dollars. The one or more execution plans may identify various execution parameters with varying bid amounts for the term “notebook computer.” The one or more digital ads and associated target and constraint information are used to generate permutations of the allowed execution parameters for a given advertiser's budget.

The one or more keywords associated with displaying the one or more digital ads in a given advertiser's budget may be used by a forecasting component to generate a forecast of the performance of a given digital ad, step 415. A forecasting component may receive one or more keywords and provide information, using historical data, on the one or more digital ads displayed in response to the one or more keywords. With reference to the value funnel illustrated in FIG. 3, the forecasting component may determine the expected number of impressions, leads, browsers, shoppers and conversions, the return on advertisement spend as well as other events, for one or more digital ads displayed in response to one or more keywords at a particular bid amount based upon historical data.

The execution parameters for the one or more execution plans for a given advertiser's budget are annotated with the forecast data, step 420. For example, a given digital ad for the keywords “notebook computer” may have a maximum bid constraint of $1 and a minimum rank position of four. The forecast data may indicate that a bid of eighty-nine cents for displaying a digital ad in response to the query “notebook computer” results in a digital ad being displayed in position four of a ranked list of digital ads. The forecast data may further indicate that a bid of eighty-nine cents results in an average of one hundred impressions, fifty leads, thirty browsers, twenty shoppers, and two conversions. The execution plan identifying a bid of eighty-nine cents for the term “notebook computer” is annotated with the corresponding forecast data.

Similarly, the forecast data may indicate that a bid of ninety-three cents for displaying a digital ad in response to the query “notebook computer” results in a digital ad being displayed in position three of a ranked list of digital ads. The forecast data may further indicate that a bid of ninety-three cents for the term “notebook computer” results in an average of two hundred impressions, eighty leads, forty browsers, thirty shoppers, and eight conversions. The execution plan identifying a bid of ninety-three cents for the term “notebook computer” is annotated with the corresponding forecast data. The various bid execution parameters of the one or more execution plans for the digital ads in an advertiser's budget are annotated with the corresponding forecast data.

The execution parameters of the one or more execution plans for a given advertiser's budget may be further annotated with advertisement specific analytics data, step 425. For example, the forecast data may indicate that a digital ad displayed in response to the query terms “notebook computer” at a bid of ninety-five cents will receive an average of one hundred impressions, fifty leads, thirty browsers, twenty shoppers, and two conversions. However, analytics data may indicate that a given digital ad performed better or worse than indicated by the forecast data. For example, a given digital ad displayed in response to the terms “notebook computer” may have actually received two hundred impressions, eighty leads, forty browsers, thirty shoppers and three conversions. The execution parameters for the one or more execution plans are thus annotated with advertisement specific analytics data indicating the actual performance of the one or more digital ads in a given execution plan, step 425.

A scoring function is applied to the execution parameters of a given execution plan using the forecast data, the advertisement specific analytics data and the advertiser specified values in the value funnel associated with the one or more advertising events, step 430. The scoring function is used to calculate an efficiency value for the one or more digital ads in a given advertiser's budget based upon the execution parameters associated with a given digital ad in a given execution plan. In one implementation, a scoring function that may be used to calculate an efficiency value of a given digital ad based upon the execution parameters of a given execution plan is;

$$S ( A ) = {\sum }_{m = [ i , l , a , r ]} ( {F ( {A}_{S} )}_{m} * {Δ ( A , F ( {A}_{S} ) )}_{m} * {V ( A )}_{m} ) ,$$

where S is the scoring function, A is a given digital ad, A_{S} is the search term for digital ad A, F is the forecast, Δ is the advertisement specific modifier based upon a given advertisement's analytics data, V is the value function and m is a given step in the value funnel (impressions, leads, browsers, shoppers, conversions and return on ad spend). An efficiency value is calculated for each digital ad in the one or more execution plans for a given advertiser's budget, step 430. The one or more digital ads in the one or more execution plans for a given advertiser's budget are sorted in descending order according to efficiency value, step 435.

A first digital ad is selected from a given execution plan, step 440. A check is performed to determine whether the selected digital ad is already in the media plan being generated, step 445. If the selected digital ad is not in the media plan, the digital ad is added to the media plan, and the cost associated with the digital ad is removed from the budget, step 455. The cost associated with a given digital ad is calculated using the forecast data for a given bid amount for the one or more keywords associated with the given digital ad. For example, the forecast data may indicate that the term “notebook computer” costs ten cents per impression and receives an average of one hundred impressions in a given period of time. Based upon the forecast data, at a bid amount of ten cents, an advertiser will be charged $10.00 (e.g., ten cents per impression*100 impressions) for a digital ad displayed in response to the term “notebook computer.”

If the digital ad selected is already in the media plan, step 445, the digital ad in the media plan is removed and the cost associated with the removed digital ad is released from the budget, step 450. The selected digital ad is added to the media plan and the cost associated with the selected digital ad is added to the budget, step 455. A check is performed to determine whether a given advertiser's budget has been exhausted, step 460. If a given advertiser's budget is exhausted, the media plan is complete and may be executed or stored in a data store for later execution or viewing by a given advertiser, step 465. If a given advertiser's budget is not exhausted, a next digital ad from the one or more execution plans is selected for analysis, step 440.

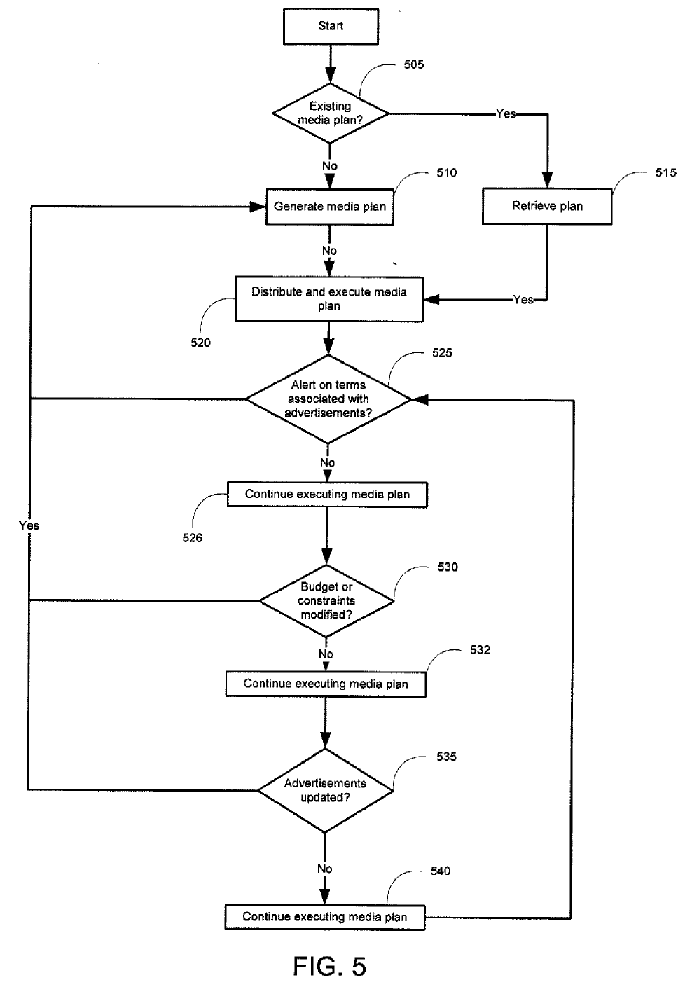

FIG. 5 is a flow diagram illustrating a method for executing and monitoring a media plan for one or more digital ads in a given advertiser's budget. A check is performed to determine whether a media plan exists for the one or more digital ads in a given advertiser's budget, step 505. If an existing media plan is found, the media plan may be retrieved, e.g., from a media plan data store, step 515. In some implementations, an advertiser may select a media plan for execution from a plurality of media plans. Alternatively, or in conjunction, a media plan may be automatically selected. If an existing media plan is not found, a new media plan may be generated according to the methods described above, step 510. The one or more digital ads and associated bid execution parameters of a given media plan are delivered to one or more channels, step 520, which according to some implementations may comprise a web site or a search engine. The one or more digital ads in a given media plan may be distributed by a given channel based upon bid amount and may be viewed and selected by Internet users of client devices.

The one or more channels that receive a media plan may be monitored to identify trends in the search requests or keywords entered by Internet users of client devices associated with one or more digital ads in a media plan. Similarly, the one or more channels that receive a media plan may be monitored to identify trends in the websites accessed by Internet users of client devices. A check is periodically performed to determine any significant deviations in the quantity of Internet users submitting search requests for terms associated with the one or more digital ads of a given advertiser's budget or users accessing one or more websites or digital ads associated with one or more terms in order to generate an alert, step 525.

If a significant deviation in the quantity of Internet users submitting search requests or accessing digital ads or web sites associated with one or more terms is found, an alert may be generated to create new media plan, step 510. For example, if a significant increase is found for one or more terms, an alert may be generated which results in the construction of a new media plan identifying execution parameters with greater bids for the one or more terms that received increased user requests. If an alert on one or more terms associated with one or more digital ads in a given media plan is not generated, the channel continues to execute the existing media plan, step 526.

A check is performed to determine whether a given advertiser has modified the budget associated with one or more digital ads or whether an advertiser has modified one or more constraints associated with one or more digital ads in a given budget, step 530. If an advertiser has modified a budget or constraint, a new media plan is generated to optimally apportion the modified budget, step 510. Similarly, if an advertiser has modified a constraint, a new media plan is generated taking into account the modified constraints, step 510. If an advertiser has not modified an existing budget or any constraints associated with one or more digital ads in a given budget, the channel continues to execute the existing media plan, step 532.

An additional check is performed to determine whether an advertiser has modified any of the one or more digital ads in a given advertiser's budget, step 535. If a digital ad has been removed from or added to an existing budget, a new media plan is generated for the modified budget over a set of digital ads, step 410. If no modifications have been made to the digital ads in an existing budget, the channel continues executing the media plan, step 540.

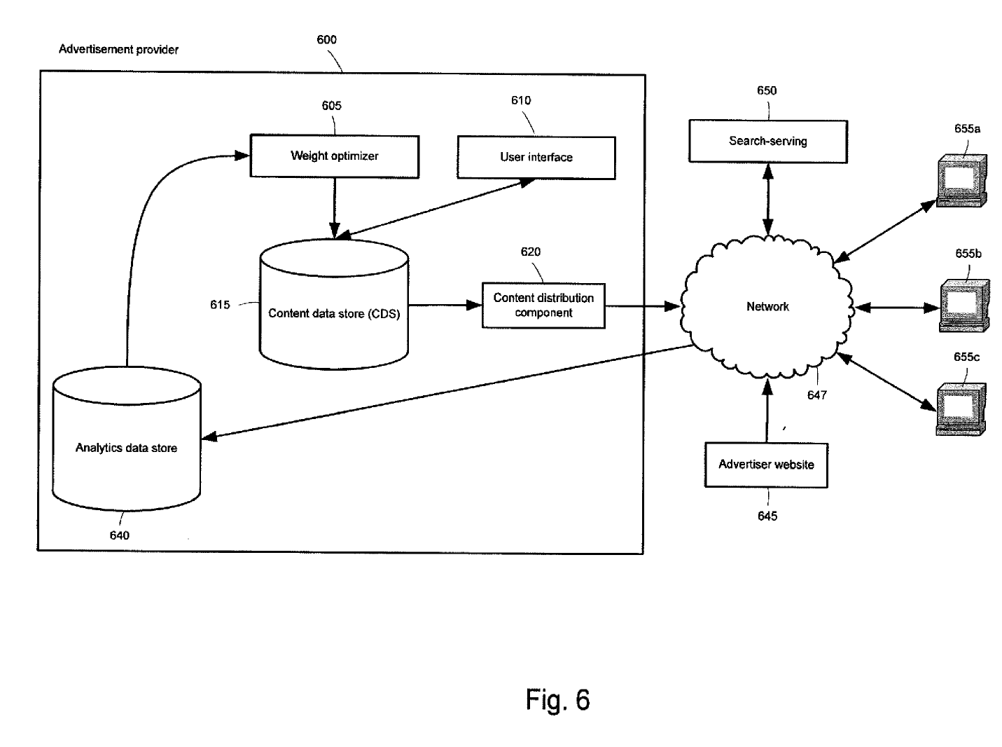

FIG. 6 is a block diagram of a system for optimizing the selection of digital ads for delivery to client devices. Generally, client devices 655a, 655b and 655c are communicatively coupled to a network 647, which may include a connection to one or more local and/or wide area networks, such as the Internet. In some implementations, client device 655a, 655b and 655c are general purpose personal computers comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Client devices 655a, 655b and 655c communicatively coupled to a network 647 may transmit search requests and receive a plurality of digital ads in response to the respective requests. Similarly, client devices may access websites with embedded digital ads, receive digital ads as pop-up ads, etc. The digital ads displayed to client devices 655a, 655b and 655c are stored and retrieved from an ad data store 615. The ad data store 615 is operative to maintain one or more digital ads and may comprise one or more accessible memory structures such as a database, CD-ROM, tape, digital storage library, etc. The ad data store may be implemented as a database or any other type of storage structure capable of providing for the retrieval and storage of a variety of data types. The ad data store may store a variety of digital ad data types including websites, text, video, images, banners, links, etc. Digital ads at the ad data store 615 may be maintained in groups according to advertiser, product, category, or a combination thereof. In one implementation, digital ads are stored in the ad data store 615 in groups according to a given product or service offered by a given advertiser. In other implementations, digital ads are stored in the ad data store in groups according to the time of the day the digital ads are distributed. Those of skill in the art recognize other methods for storing one or more digital ads in one or more groups.

Advertisers may access the ad data store 615 through the use of a user interface 610 the ad provider 600 makes available. The user interface 610 provides an advertiser with the ability to view existing digital ads in the ad data store 615, add new digital ads to the ad data store 615, modify existing digital ads in the ad data store 615, remove digital ads from the ad data store 615, create new groups of digital ads within the data store 615, etc. The user interface 610 may further be used to define advertiser preferences with respect to ad groups. For example, an advertiser may specify a classification for a given digital ad or may define threshold values used in determining the frequency with which to distribute a digital ad. The user interface 610 may be a graphical user interface, a command line interface or other interface known to those of skill in the art.

The content distribution component 620 is in communication with the ad data store 615 and retrieves digital ads for delivery to the search-serving component 650 via the network 647. The content distribution component may retrieve and deliver digital ads in response to requests from client devices 655a, 655b and 655c or the search-serving component 650. The content distribution component 620 may also retrieve and deliver digital ads in response to modifications to digital ads contained in the ad data store 615. For example, an advertiser may replace or update one or more digital ads contained in the ad data store 615. The changes made to the digital ads in the ad data store 615 are automatically propagated to the search-serving component 650 via the content distribution component 620.

The search-serving component 650, communicatively coupled to the network 647, receives digital ads from the ad provider 600 and generates tracking codes for the digital ads received, thereby allowing the ad provider 600 to track user interactions with digital ads. Alternatively, tracking codes may be generated by the content distribution component 620. In one implementation, tracking codes are placed in the destination URL for the one or more digital ads received by the search-serving component 650. In other implementations, the search-serving component generates tracking codes associated with serving a given digital ad and the selection of an digital ad by an Internet user of a client device 655a, 655b and 655c. In yet other implementations, tracking codes may be specified for each respective digital ad maintained in the ad data store 615. When digital ads are received by the search-serving component 650, the search-serving component 650 may attach the appropriate tracking codes depending on which digital ads are actually served.

The search-serving component 650 distributes the digital ads to websites being accessed or viewed by client devices 655a, 655b and 655c communicatively coupled to the network 647. The search-serving component may select one or more digital ads to be displayed on a client device 655a, 655b and 655c based upon the context of a request. For example, the search-serving component may serve one or more digital ads in response to a search query submitted to a search engine. Similarly, the search-serving component may serve one or more digital ads to one or more affiliate web pages based upon, for example, the context of the affiliate web page. In some implementations, tracking codes associated with the delivery of a digital ad provide information to the analytics data store 640 indicating delivery of a given digital ad.

The digital ads sent to a given client device 655a, 655b and 655c by the search-serving component 650 may be selected by an Internet user of a client device 655a, 655b and 655c. In one implementation, the selection of a digital ad by an Internet user of a client device 655a, 655b and 655c is reported to the analytics data store 640 using the tracking codes associated with a given digital ad. When an Internet user selects a digital ad distributed by the search-serving component 650, the user is redirected to the respective advertisers website 645. In addition to tags in digital ads, an advertiser's website may contain tags providing information on the web site being accessed. For example, tags contained within an advertiser's one or more web pages may indicate whether the webpage is associated with purchasing, browsing, etc. The information provided by the tags contained in an advertiser's one or more webpages may be used by the tracking codes associated with a given digital ad to deliver data to the analytics data store 640. The information associated with an advertisers web site and delivered to the analytics data store 640 may comprise the digital ad selected, the time of day, the month, information stored in a user profile, the ranking of the digital ad in ranked result set, etc.

The analytics data store 640 is an accessible memory structure such as a database, CD-ROM, tape, digital storage library, etc. The analytics data store 640 maintains information regarding user interactions with digital ads and may be implemented as a database or any other type of data storage structure capable of providing for the retrieval and storage of a variety of data types. The analytics data store 640 may store a variety of data types related to digital ads. Advertisement information in the analytics data store 640 may be maintained in groups according to advertiser, product, category, or a combination thereof. Advertisement information in the analytics data store 640 may also be maintained according to advertiser specified groups.

The analytics data store 640 is periodically populated with data indicating user interactions with digital ads, which may also include interactions with an advertiser web site 645. The analytics data store 640 receives advertisement data associated with a given digital ad and determines whether an existing record exists for the advertisement data received. If the analytics data store 640 locates a record, the analytics data store 640 updates the existing record to indicate further user interactions with a given digital ad or advertiser web site 645. For example, if the analytics data store 640 receives information indicating that an Internet user of a client device 655a, 655b and 655c selected a given digital ad, the analytics data store 640 determines whether a record exists for the given digital ad. If a record exists, the record is updated to indicate that an additional user selected the given digital ad. If a record does not exist corresponding to the information received, a new entry is created in the analytics data store 640 for the given digital ad's information. In some implementations, a record in the analytics data store 640 may also store information regarding user characteristics specified in a user profile. For example, if a user selects a given digital ad, information stored in a user profile, including but not limited to demographic information, age, sex, etc., may be delivered and stored in the analytics data store 640. Alternatively, an existing user profile may be updated.

The weight optimizer 605 utilizes the information stored in the analytics data store 640 to normalize click through rates and assign weights to digital ads within a group of digital ads in order to optimize the selection of digital ads from the group for distribution. The weight optimizer 605 retrieves data for a group of digital ads from the analytics data store 640. In some implementations, a group of digital ads comprises one or more digital ads provided by an advertiser to advertise a similar product or service. In other implementations, a group of digital ads comprises one or more digital ads provided by a single advertiser and displayed during a particular time of day. In yet other implementations, a group of digital ads comprises one or more digital ads provided by a single advertiser and displayed to users having similar characteristics as specified in user profiles. Those of skill in the art recognize other groupings for one or more digital ads fall within the scope of the present invention.

The weight optimizer 605 determines a proper algorithm to use in assigning weights to the one or more digital ads within a group of digital ads. In some implementations, the weight optimizer 605 selects an algorithm based upon the quantity of digital ads in a given group of digital ads. The weight optimizer 605 assigns an initial weight to digital ads by normalizing the click through rate for digital ads in a group and assigning a given digital ad a weight based upon the normalized click through rate. As additional data is gathered by the analytics data store for the one or more digital ads comprising a group of digital ads, the weight optimizer modifies the weight associated with a given digital ad. In some implementations, the weight optimizer 605 decreases or increases the weight associated with a given digital ad, or marks an digital ad for non-delivery, based upon a comparison between a given digital ad's normalized click through rate and the average normalized click through rate for digital ads in the group.

In other implementations, the weight optimizer 605 decreases or increases the weight associated with a given digital ad, or marks a digital ad for non-delivery, based upon a comparison between digital ads in the group. In other implementations, the weight optimizer 605 decreases or increases the weight associated with a given digital ad based upon a comparison with the average normalized click through rate of digital ads in a group. An average normalized click through rate is calculated for the one or more digital ads comprising a group of digital ads. A digital ad is selected and a comparison is made between the selected digital ad's normalized click through rate and the average normalized click through rate of the one or more digital ads comprising the group of digital ads. If the average normalized click through rate of the one or more digital ads comprising the group of digital ads exceeds the selected digital ad's normalized click through rate with statistical significance, the selected digital ad is marked for non-delivery,

The weight optimizer 605 may be configured to periodically calculate weights for digital ads stored in the ad data store 615. For example, the weight optimizer 605 may be configured to assign weights to digital ads once every 24 hours, once a week, etc. Furthermore, the weight optimizer 605 may be configured to execute a normalization and weight assignment algorithm until the weight optimizer has determined the N most effective digital ads, where N may be a predetermined threshold or defined by an advertiser using the user interface 610 of the ad provider 600. Additionally, the weight optimizer 605 may be configured to execute a normalization and weight assignment algorithm upon receipt of new digital ads from an advertiser or upon detecting the removal of a digital ad by an advertiser.

The weights assigned to the one or more digital ads in a group of digital ads by the weight optimizer 605 are stored in the ad data store 615 with corresponding digital ads. The search-serving component 650 utilizes the weights associated with one or more digital ads in a given group of digital ads to determine which digital ads to distribute in response to a request. When the ad provider 100 receives requests, the content distribution component 620 retrieves one or more groups of digital ads from the ad data store 615 in response to the request. The content distribution component delivers the digital ads to the search-serving component 650. The search-serving component 650 may analyze the weights of the one or more digital ads in the one or more groups of digital ads delivered from the content distribution component 620. In some implementations, the search-serving component 650 selects the digital ads with the greatest weights to display to users of client devices 655a, 655b and 655c. Therefore, users of client devices 655a, 655b and 655c receive digital ads from a group comprised of one or more digital ads that have the greatest weights, increasing the likelihood that a given digital ad is selected. In other implementations, the weights associated with the one or more digital ads in the one or more groups of digital ads are utilized by the search-serving component 650 to bias a random choice between two or more digital ads from a given advertiser. For example, the content distribution component 620 may identify a plurality of digital ads from a given advertiser response to a given request. The search-serving component 650 may be configured to select only one digital ad from a given advertiser in response to a given request. Therefore, the search-serving component 650 may utilize the weights associated with the digital ads delivered from the content distribution component 620 to bias a random choice between two or more digital ads from a given advertiser response to a given request. For example, the content distribution component 620 may deliver digital ad A and digital ad B from a given advertiser in response to a given request. The search-serving component 650 may determine that digital ad A has an associated weight of 0.75 and digital ad B has an associated weight of 0.25. The search-serving component 650 may generate a random number between zero (0) and one (1). If the random number generated is less than or equal to 0.75 (the weight associated with digital ad A), digital ad A will be selected by the search-serving component 650. Similarly, if the random number generated is greater than 0.75, digital ad B will be selected by the search-serving component 150.

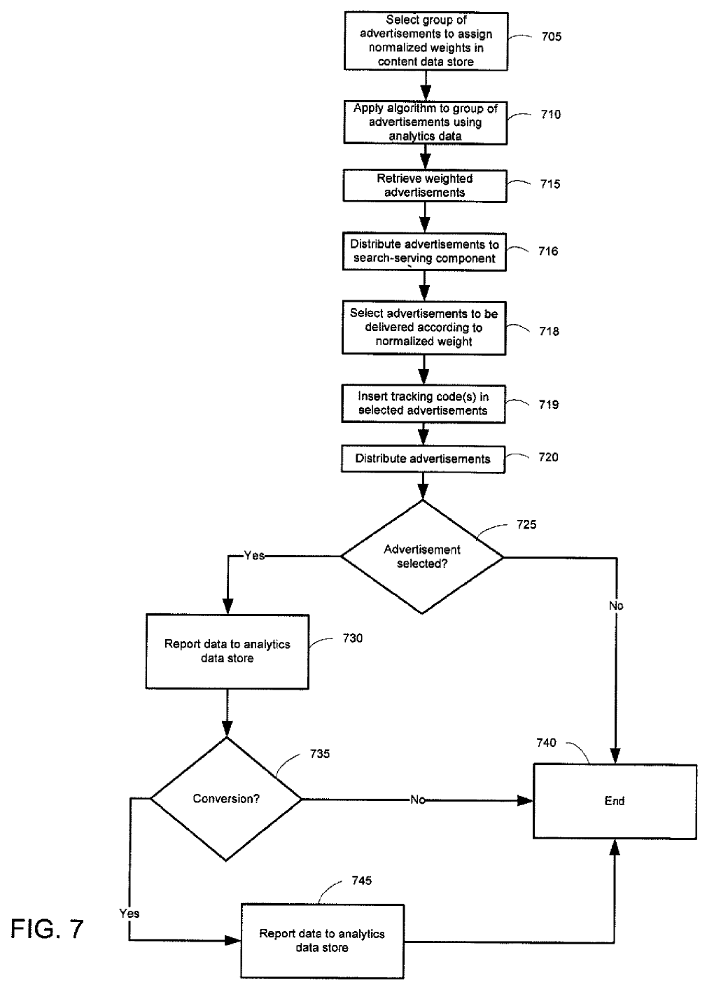

FIG. 7 is a flow diagram of a method for optimizing the selection of one or more digital ads from among a group of digital ads to be delivered and tracking user interactions with the one or more digital ads. A group of digital ads is selected for delivery optimization from the one or more groups of digital ads stored in an ad data store, step 705. In some implementations, a group of digital ads comprises one or more digital ads from a given advertiser directed towards advertising a similar product or service. In other implementations, a group of digital ads comprises one or more digital ads to be displayed to a user in response to a certain query. In yet other implementations, a group of digital ads comprises one or more digital ads to be displayed to users with certain characteristics as specified in user profiles. In yet other implementations, a group of digital ads comprises on or more digital ads to be included in a group as specified by a given advertiser.

Analytics data corresponding to the one or more digital ads comprising a group of digital ads is retrieved from an analytics data store, step 708. The analytics data may comprise information indicating the number of times a given digital ad was selected by users when displayed in a certain position within a ranked list of digital ads, the time of day a digital ad was displayed, characteristics of a user who selected the digital ad (which may be specified in a user profile), etc. The analytics data corresponding to the one or more digital ads is used to generate normalized click through rates for the one or more digital ads comprising the group of digital ads. For example, a group of digital ads from a given advertiser may comprise one or more digital ads all directed at advertising “wireless routers.” The analytics data store may contain information indicating the number of times each digital ad in the “wireless router” digital ad group was selected.

In some implementations, a weight optimizer is used to normalize the click through rates of the one or more digital ads comprising a group of digital ads and assign weights to digital ads using the data retrieved from the analytics data store. The process of assigning one or more digital ads a weight may be performed using a normalizing algorithm, an empirical body of data, and the data retrieved from the analytics data store, step 710. According to one embodiment of the invention, the normalizing algorithm selected to assign weights to the one or more digital ads comprising a group of digital ads is based upon the quantity of digital ads in the group. For example, a threshold value corresponding to the number of digital ads in a group may be used to select the appropriate normalizing algorithm.

The weights assigned to the one or more digital ads comprising a group of digital ads are stored in the ad data store. When a request is received for digital ads, a group of digital ads and associated weights is retrieved from the ad data store in response to the request, step 715. The content distribution component delivers the group of digital ads to a search-serving component, step 716. The search-serving component examines the one or more digital ads comprising a group of digital ads and the weights associated with the one or more digital ads. The search-serving component utilizes the weights associated with the one or more digital ads comprising a group of digital ads to determine which digital ads to distribute, step 718. In some implementations, the search-serving component selects digital ads that have an associated weight above a predetermined threshold. In other implementations, the search-serving component selects digital ads having an associated weight above a threshold defined by a given advertiser. In yet other implementations, the search-serving component selects the N digital ads with the greatest weight. In yet other implementations, the search-serving component utilizes the weights to bias a random choice between two or more digital ads from a given advertiser.

The search-serving component generates tracking codes associated with the one or more digital ads selected for distribution, step 719. The one or more digital ads are distributed with tracking codes that the system uses to monitor user interactions, step 720. For example, digital ads distributed by the search-serving component may be viewed and selected by users of client devices. The tracking codes associated and delivered with an digital ad are used to record selection of an digital ad by a user, step 730.

As shown in FIG. 7, if an digital ad is not selected, no information is collected for the digital ad distributed, step 740. In other implementations, if a digital ad is not selected, information indicating that the digital ad was distributed and not selected may be collected. Alternatively, if a digital ad is selected, a user is redirected to the advertiser's web site associated with the digital ad selected. Pages comprising the website associated with the selected digital ad may contain tags that comprise one or more pieces of data that may be retrieved and delivered to the analytics data store. For example, tags in a given advertiser's web site may comprise data identifying the type of page, such as whether a page is associated with purchasing, shopping, etc. The tags may further provide timestamp information to indicate when a digital ad was selected.

The information specified by the tags within the pages comprising a given advertisers web site that a user accesses may be delivered to the analytics data store. An advertiser may also include tags in any of the one or more web pages comprising the advertiser's web site. For example, an advertiser may insert tags in the web pages associated with purchasing the advertiser's products or services. When the web page associated with purchasing is accessed, the tags within the purchasing web page provide information specifying that a purchasing web page of a given advertiser's web site was accessed. A check may be performed to determine whether a user accessing an advertiser's web page made a purchase, step 735. If a purchase was made, the information contained within the tags inserted in the purchasing web page are delivered to the analytics data store, step 745. Furthermore, the tracking codes associated with a given digital ad may be used to identify the digital ad that resulted in the users purchase.

As shown in FIG. 7, if a user does not make a purchase, no information is retrieved or delivered, step 740. In other implementations, if a user did not make a purchase but accessed a purchasing web page, such information may be delivered to the analytics data store. It should be noted that the while the presently illustrated method describes tagging a final web page in a purchase process, an advertiser may insert tags on any page significant to the advertiser in the purchasing process. For example, an advertiser may insert tags in web pages where a user browses models of a certain product, or web pages that prompt a user to enter user information, such as city, state, sex, age, etc.

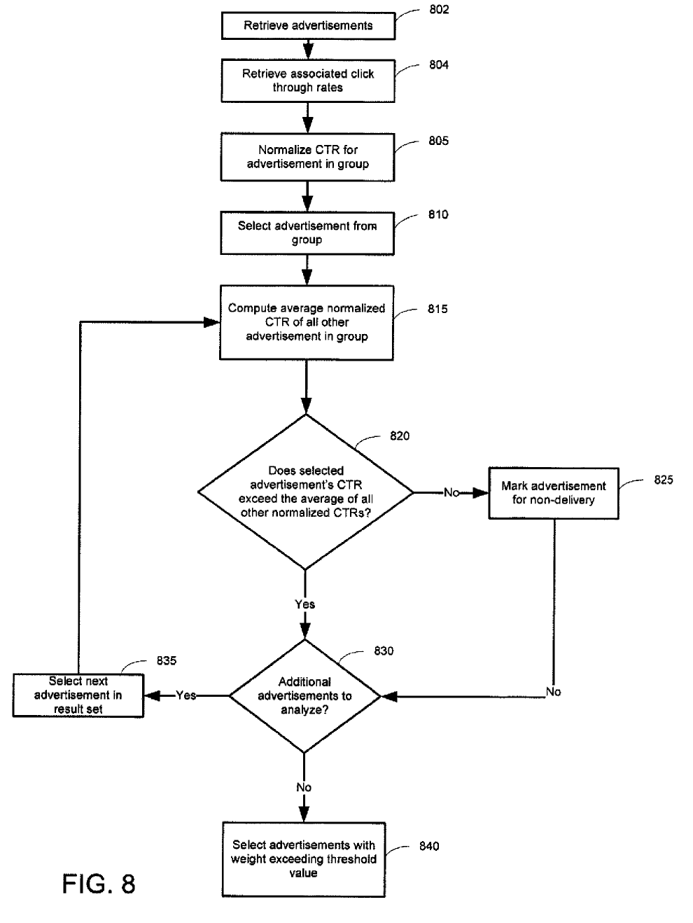

FIG. 8 is a flow diagram of a method for optimizing the delivery of one or more digital ads within a group of digital ads. A group of digital ads is retrieved in response to a query or other request for digital ads, step 802. Additionally, click-through-rates associated with the one or more digital ads comprising the group of digital ads are retrieved, step 804. The click through rates corresponding to the one or more digital ads within the group are normalized using the retrieved click through data and empirical data corresponding to a selected normalization algorithm, step 805 The normalized clicks through rates are used to assign weights to the one or more digital ads within the group.

In one implementation, the normalization process of step 805 is performed to normalize differences in click through rates due to digital ads appearing in different positions within a ranked result set. As previously noted, digital ads appearing first in a ranked result set are more likely to be selected by a user than digital ads appearing second, third, etc. Therefore, a digital ad appearing first in a ranked result set may have a significantly greater click through rate than a digital ad appearing second, third, etc. A normalization of the click through rates, using empirical data, compensates for the difference in rank positions of the one or more items comprising a group of digital ads. The empirical body of data used by the selected normalization algorithm may provide information specifying the likelihood of a digital ad being selected by a user when displayed in position one, two, three, etc., of a ranked group of digital ads.

In other implementations, the normalization process of step 805 is performed to normalize differences in click through rates due to digital ads appearing at different times of the day, different days of the week, etc. For example, digital ads appearing at 9:00 a.m. or 7:00 p.m. may receive a greater click through rate than digital ads appearing at 4:30 a.m. or 11:00 p.m. Digital ads appearing during different time periods are normalized according to time to compare the effectiveness of one or more digital ads in a given group of digital ads. In yet other implementations, the normalization process of step 805 is performed for multiple factors. For example, normalization may be performed for click through rates associated with a certain time of day in conjunction with click through rates associated with certain user characteristics as specified in a user profile. Those of skill in the art recognize other methods for which normalization may be necessary to ascertain the effectiveness of one or more digital ads within a group of digital ads.

In one implementation, a normalized click-through rate for a given digital ad is computed using the equations:

$${I}_{N} = {\sum }_{a , b} {I}_{a , b} , \\ {C}_{N} = {\sum }_{a , b} \frac{{C}_{a , b}}{{CTRp}_{a} * {CTRt}_{b}} , and$$

$${CTR}_{N} = \frac{{C}_{N}}{{I}_{N}} ,$$

where a is the position a given digital ad was displayed or clicked, b is the hour-of-week the given digital ad was displayed or clicked, CTRp is a position-based factor that indicates the relative likelihood of a digital ad being clicked in a particular position. CTRt is a time-based factor that indicates the relative likelihood of a digital ad being clicked at a particular time. I_{a,b} is the number of times the given digital ad was displayed in position a in hour b, C_{a,b} is the number of clicks the given digital ad received in position a in hour b, I_{N} is the normalized number of times the given digital ad was displayed, C_{N} is the normalized number of clicks for the given digital ad, and CTR_{N} is the normalized click-through rate for the given digital ad.

The normalization equations presented above, or any other appropriate normalization technique, is executed for the one or more digital ads within a group of digital ads to assign the one or more digital ads associated weights. The group of digital ads is traversed, and a digital ad is selected from among the group, 810. The normalized click through rates associated with the remaining one or more digital ads within the group of digital ads are used to calculate an average normalized click through rate, step 815. The normalized click through rate associated with the selected digital ad is compared against the average normalized click through rate of the one or more digital ads comprising the group, step 820. If the selected digital ad's normalized click through rate does not exceed the average normalized click through rate for the group of digital ads, the selected digital ad is assigned a weight of zero or otherwise marked for non-delivery, step 825. If the selected digital ad's normalized click through rate exceeds the average normalized click through rate of the remaining one or more digital ads comprising the group of digital ads, step 820, the digital ad's weight remains unchanged.

A check is performed to determine whether there are additional digital ads among the group to analyze, step 830. If additional digital ads need to be analyzed, step 830, a subsequent digital ad is selected from the one or more digital ads comprising the group, step 835. In FIG. 8, after analyzing digital ads in the group, digital ads exceeding a threshold value are selected for delivery to client devices or a distribution component, step 840. In other implementations, the one or more digital ads within the group may be stored with associated weights in an ad data store.

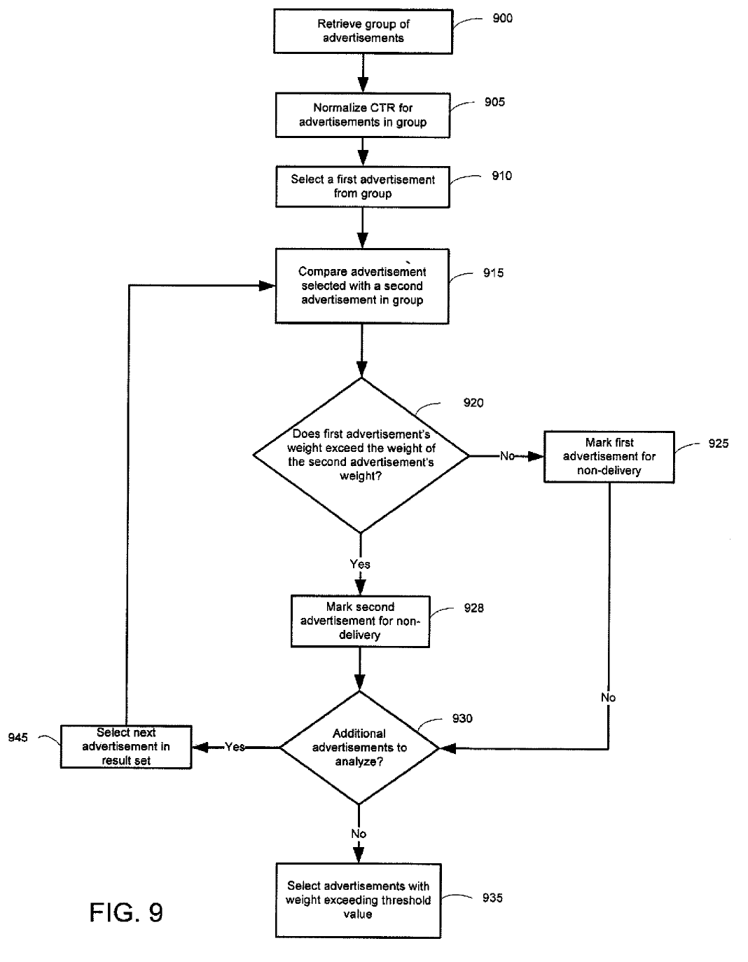

FIG. 9 is a flow diagram of a method for optimizing the delivery of one or more digital ads from a group of digital ads. A group of digital ads is retrieved in response to a query or other request for digital ads, step 900. Additionally, click-through-rates associated with the one or more digital ads comprising the group of digital ads are retrieved. The click through rates corresponding to the one or more digital ads within a group are normalized using empirical data corresponding to a selected normalization algorithm and the retrieved click through data, step 905. The normalized click through rates may be used to assign weights to the one or more digital ads within the group. According to one embodiment of the invention, the normalization process of step 905 is performed to normalize differences in click through rates due to digital ads appearing in different positions within a ranked result set. According to another embodiment of the invention, the normalization process of step 905 is performed to normalize differences in click through rates due to digital ads appearing at different times of the day, different days of the week, etc. In other implementations, the normalization process of step 905 is performed to normalize differences in click through rates due to a plurality of factors.

A first digital ad is selected from the one or more digital ads within the group, step 910. The normalized click through rate of the digital ad selected is compared against the normalized click through rate of a second digital ad selected from the one or more digital ads within the group, step 915. In FIG. 9, a check is performed to determine whether the normalized click through rate of the first digital ad selected exceeds the normalized click through rate of the second digital ad, step 920. If the normalized click through rate of the first digital ad does not exceed the normalized click through rate of the second digital ad, the first digital ad is assigned a weight of zero or otherwise marked for non-delivery, step 925. Alternatively, if the normalized click through rate of the first digital ad exceeds the normalized click through rate of the second digital ad, the second digital ad is assigned a weight of zero or otherwise marked for non-delivery, step 928. If there are additional digital ads to analyze in the group, step 930, a subsequent digital ad is selected for comparison, step 945. Digital ads in the group are analyzed, step 930, and digital ads exceeding a normalized click through rate threshold are selected for delivery to a client device or a distribution component, step 935. In other implementations, digital ads and associated weights are stored in an ad data store.

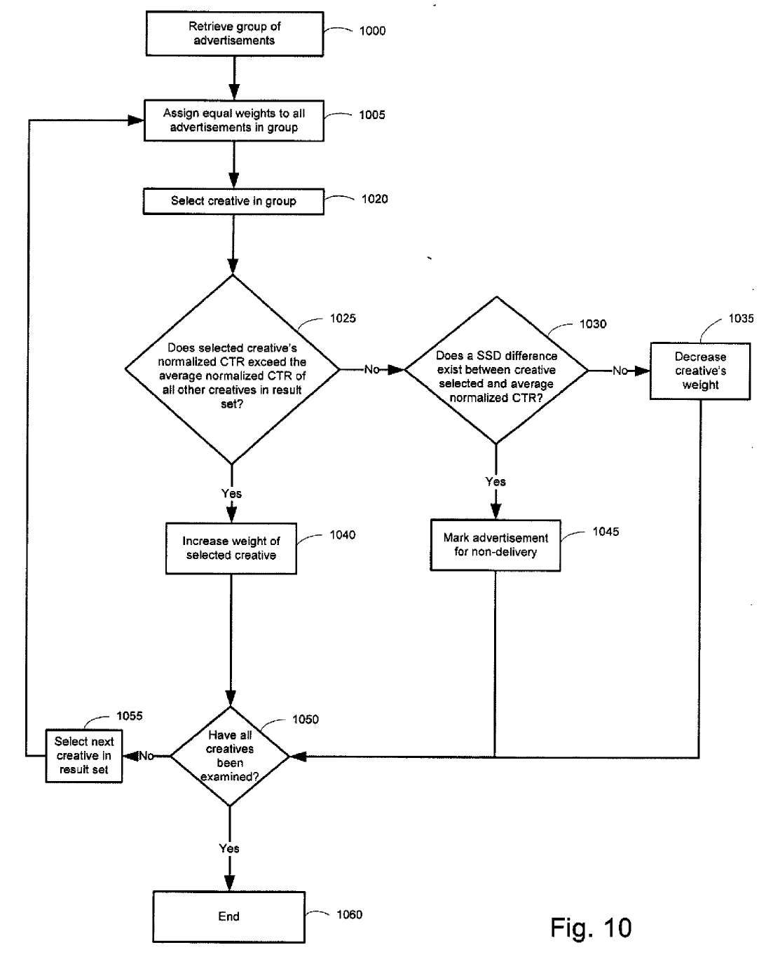

FIG. 10 is a flow diagram of another method for optimizing the delivery of one or more digital ads within a group of digital ads. A group of digital ads is selected from an ad data store for analysis, step 1000. The one or more digital ads comprising the group are assigned equal weights, step 1005. In some implementations, the sum of the weights assigned to the one or more digital ads comprising a group is equal to one (“1”). A digital ad is selected from among the one or more digital ads comprising the group, step 1020. The digital ad's associated normalized click through rate is compared with the average normalized click through rate of all other digital ads comprising the group, step 1025. If the selected digital ad's normalized click through rate exceeds the average normalized click through rate of all other digital ad's comprising the group, the weight associated with the selected digital ad is increased, step 1040. In some implementations, the weight is increased one percent.

If the selected digital ad's normalized click through rate does not exceed the average normalized click through rate of the one or more digital ads comprising the group, step 1025, a check is performed to determine whether a statistically significant difference exists between the selected digital ad's normalized click through rate and the average normalized click through rate of the one or more digital ads within the group, step 1030. According to one embodiment of the invention, a chi square test for statistical significance is used to determine whether a statistically significant difference exists between the selected digital ad's normalized click through rate and the average normalized click through rate of the group. If a statistically significant difference is found, the selected digital ad is given a weight of zero or otherwise marked for non-delivery, step 1045. If a statistically significant difference is not found, the selected digital ad's weight is decreased, step 1035. In some implementations, the weight of the selected digital ad is decreased one percent. A check is performed to determine whether additional digital ads within the group of digital ads require analysis, step 1050. Digital ads are selected and analyzed, step 1055, until digital ads comprising the group have been analyzed, step 1060.

The weights associated with the one or more digital ads comprising a group of digital ads may be utilized by a serving component to bias a random choice between two or more digital ads from a given digital ad in response to a given request. The search-serving component of the system illustrated in FIG. 6 may be configured to distribute only one digital ad from a given advertiser's one or more digital ads responsive to a given request.

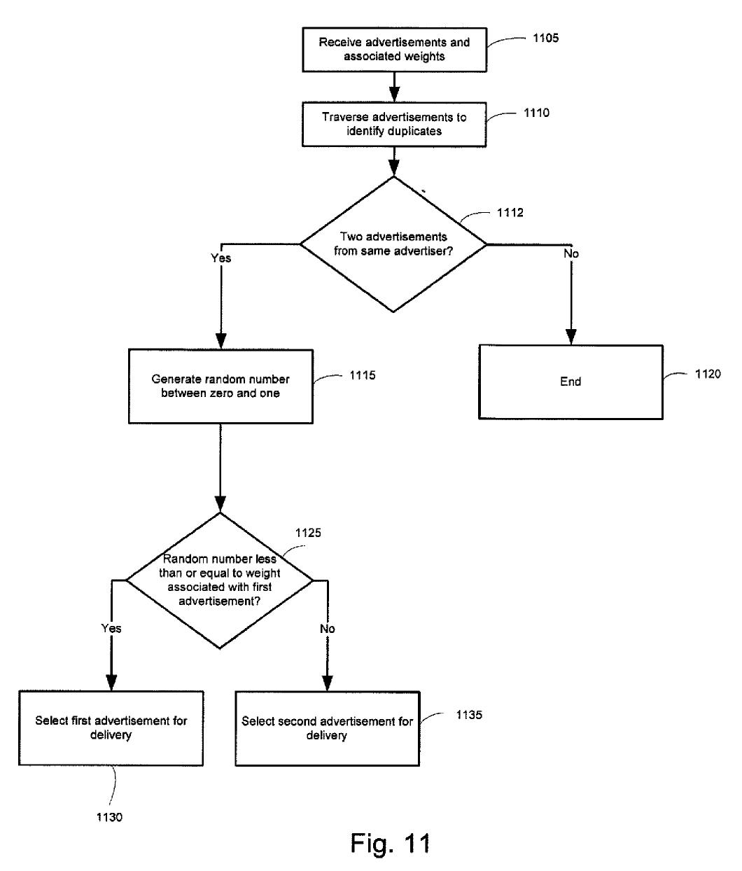

FIG. 11 is a flow diagram of a method for randomly selecting a digital ad from among two or more digital ads from a given advertiser responsive to a given request utilizing the weights associated with each respective digital ad. The search-serving component receives the digital ads comprising a group of digital ads, as well as each respective digital ad's associated weight, step 1105. The search-serving component traverses the plurality of digital ads comprising the group of digital ads to identify two or more digital ads from a given advertiser responsive to a given request, step 1110. A check is performed to determine whether two or more digital ads from a given advertiser are in the group of digital ads, step 1112. If two or more digital ads from the same advertiser are not found, processing ends, step 1120. When two or more digital ads from the same advertiser are found within the group of digital ads, the search-serving component generates a random number between zero and one, step 1115. The random number generated may be utilized to select from among the two or more digital ads from a given advertiser responsive to a given request. In some implementations, the random number generated is compared with the weights associated with the two or more digital ads from a given advertiser. A check is performed to determine whether the random number generated is less than or equal to the weight associated with a first digital ad from a given advertiser's two or more digital ads in the group of digital ads, step 1125. If the check evaluates to true, and the random number generated is less than or equal to the weight associated with the first digital ad, the first digital ad is selected for delivery, step 1130. If the check evaluates to false, and the random number is greater than the weight associated with the first digital ad, the second digital ad is selected for delivery, step 1135.

In the ad campaign optimizers described above, advertisers are provided the ability to express a value that they associate with events that result from marketing activities associated with digital ads, such as impressions, click-throughs (visitors to a website), conversions, and revenue associated with conversions. The ad campaign optimizers use these values set by the advertiser to set parameters associated with digital ads such as bid prices so that the ad campaign optimizers drive for a maximum ROI as defined by the advertiser.

There is often a lack of alignment between the optimization function as defined by the advertiser and metrics that an ad campaign optimizer typically calculate and report to the advertiser. Because of the lack of alignment, decisions by ad campaign optimizers may seem arbitrary, mysterious, or wrong to an advertiser, leading to an increase in customer inquiries to an ad provider asking if the ad campaign optimizer is operating properly. Additionally, because of the lack of alignment, it is often difficult for an ad campaign optimizer to provide feedback to advertisers (or their tools) to allow the advertiser to accurately evaluate the performance of their digital ads and/or modify the values that the advertiser has associated with events that result from marketing activities. Moreover, because the ad campaign optimizer is not calculating a metric measuring a performance of digital ads based on a value of events associated with the digital ads as defined by an advertiser, modules of an ad provider outside the ad campaign optimizer often have difficulty using the advertiser-defined objective function in other contexts to guide decisions.

To address these problems, an ad campaign optimizer such as those described above with respect to FIGS. 1-11 may calculate a performance index to measure the performance of digital ads based on the value of events associated with the digital ads as defined by an advertiser. In one implementation, the ad campaign optimizer calculates the performance index over a plurality of objects using the equation:

$${PI}_{i} = \frac{\frac{{S}_{i}}{{BE}_{i}}}{{max}_{j = 1 … N} ( \frac{{S}_{j}}{{BE}_{j}} )} ,$$

where PIᵢ is a performance index for object i, Sᵢ is a score for object i, BEᵢ is a number of billing events for object i, and 1 . . . N is the plurality of objects that the performance index is being calculated over. Examples of objects over which an ad campaign optimizer may calculate the performance index include digital ads, an ad group, an ad campaign, and terms such as keywords. The ad campaign optimizer may also calculate the performance index with respect to a variety of other dimensions, such as geographic areas, behavioral categories, demographic categories, etc.

It will be appreciated that in the performance index equation above, a denominator of the performance index scales that value of the performance index to between a range of zero to one. However, in other implementations, the ad campaign optimizer may utilize other scaling functions to scale the value of the performance index to between different ranges, such a range of zero to 100 or a range of zero to five.

The details of a scoring function used in the performance index are dependent on a nature of a digital ad. For example, in the ad campaign optimizer described above with respect to FIGS. 2-5, in one implementation, a scoring function may be calculated using the equation:

$$S ( A ) = {\sum }_{m = [ i , l , a , r ]} ( {F ( {A}_{S} )}_{m} * {Δ ( A , F ( {A}_{S} ) )}_{m} * {V ( A )}_{m} ) ,$$

where S is the scoring function, A is a given digital ad, A_{S} is the search term for digital ad A, F is the forecast, Δ is the advertisement specific modifier based upon a given advertisement's analytics data, V is the value function and m is a given step in the value funnel (impressions, leads, browsers, shoppers, conversions and return on ad spend).

The use of the number of billing events in the performance index provides the ad campaign optimizer the ability to control for the effects of volume on the magnitude of the scoring function. Additionally, the use of billing events (as opposed to any of the other event counts), aligns the resulting performance index with the ROI. The result is that when an advertiser and/or the ad campaign optimizer compares the performance index values for two digital ads that were jointly computed, a ratio of the performance index values of the two digital ads is equal to the ratio of the ROI of the two digital ads if the price per billing event is the same.

For example, if a first keyword and a second keyword are associated with digital ads of an ad group, the performance index of the first keyword is determined to be 0.50 and the performance index for the second keyword is determined to be 1.0, if a per-click cost associated with the first and second keywords are the same, the resulting ROI of the digital ads associated with the second keyword will be twice that of digital ads associated with the first keyword. Likewise, continuing with the example above, if the per-click cost associated with the second keyword were twice that of the per-click cost associated with the first keyword, digital ads associated with the first keyword would have the same ROI as digital ads associated with the second keyword. Accordingly, in some implementations, relative performance index values may indicate a relative performance of one object with respect to another object, and may indicate relative per-billing event pricing for these objects that makes sense for the advertiser.

Once an ad campaign optimizer calculates a performance index, the performance index may be used for purposes such as reporting through a graphical user interface (GUI) or an application program interface (API). The ad campaign optimizer may also use the calculated performance index as a factor in optimization of one or more digital ads. It will be appreciated that the ad campaign optimizer may additionally export the calculated performance index to other modules of an ad provider for uses in other ad campaign management functions. For example, the calculated performance index may be used with functions such as keyword expansion, offer model trimming, or modeling the performance of digital ads and/or keywords.

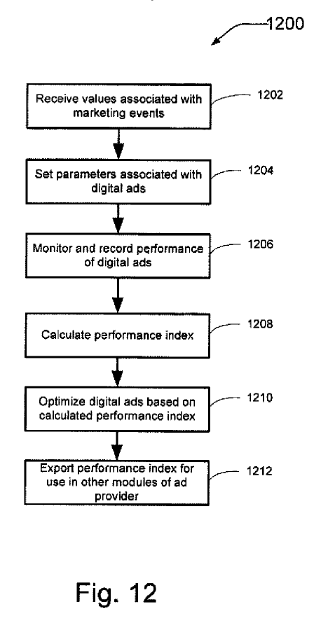

FIG. 12 is a flow diagram of a method for creating an index to measure a performance of digital ads as defined by an advertiser. The method 1200 begins at step 1202 with an ad campaign optimizer receiving a value associated with events that result from marketing activities associated with digital ads of an advertiser as described above in conjunction with FIGS. 1-11. In some implementations, an advertiser may provide values associated with impressions, click-throughs, conversions, and/or revenue associated with conversions. At step 1204, an ad campaign optimizer uses the values received at step 1202 to set parameters, such as bid prices, associated with digital ads of the advertiser in an attempt to maximum a ROI as defined by the advertiser.

At step 1206, an ad provider, ad campaign management system, and/or the ad campaign optimizer monitors and records the performance of digital ads. At step 1208, the ad provider, ad campaign management system, and/or ad campaign optimizer calculates a performance index for one or more digital ads of the advertiser that measures the performance of one or more digital ads as defined by the advertiser. In one implementation, the performance index is calculated as described above using the equation:

$${PI}_{i} = \frac{\frac{{S}_{i}}{{BE}_{i}}}{{max}_{j = 1 … N} ( \frac{{S}_{j}}{{BE}_{j}} )} ,$$

where PIᵢ is a performance index for object i, Sᵢ is a score for object i, BEᵢ is a number of billing events for object i, and 1 . . . N is the plurality of objects that the performance index is being calculated over.

At step 1210, the ad campaign optimizer optimizes one or more digital ads of the advertiser based on the one or more performance index values calculated at step 1208. For example, the ad campaign optimizer may generate or adjust media plans associated with digital ads based on a performance index, or the ad campaign optimizer may assign or adjust weights associated with digital ads based on a performance index.

At step 1212, additional actions may be performed based on the generated performance index such as generating a report identifying the calculated performance index to an advertiser, performing keyword expansion based on the performance index, performing offer model trimming, and/or modeling the performance of digital ads and/or keywords.

It is intended that the foregoing detailed description be regarded as illustrative rather than limiting, and that it be understood that it is the following claims, including all equivalents, that are intended to define the spirit and scope of this invention.

1. A method for utilizing a performance index measuring a performance of an object as defined by an advertiser, the method comprising:
receiving one or more values associated with events that result from marketing activities associated with one or more objects;
calculating a performance index associated with an object of the one or more objects, the performance index measuring a performance of the object based on the received one or more values; and
optimizing a digital ad based on the calculated performance index.

2. The method of claim 1, wherein receiving one or more values comprises:
receiving values for at least one of impressions, click-throughs, conversions, or revenue associated with conversions.

3. The method of claim 1, wherein the object comprises one of a digital ad, an ad group, an ad campaign, and a keyword.

4. The method of claim 3, wherein the performance index is calculated according to the equation:
$$PI = \frac{\frac{S}{BE}}{{max}_{j = 1 … N} ( \frac{{S}_{j}}{{BE}_{j}} )} ,$$
where PI is the performance index for the object, S is a score associated with the object, BE is a number of billing events associated with the object, and 1 . . . N is a plurality of objects over which the performance index is being calculated.

5. The method of claim 5, wherein a billing event associated with the object comprises at least one of an impression, a click-through, and a conversion.

6. The method of claim 1, wherein optimizing the digital ad based on the calculated performance index comprises at least one of:
generating a media plan associated with the digital ad based on the calculated performance index;
modifying a media plan associated with the digital ad based on the calculated performance index;
assigning a weight associated with the digital ad based on the calculated performance index; and
modifying a weight associated with the digital ad based on the calculated performance index.

7. The method of claim 1, further comprising at least one of:
performing keyword expansion based on the calculated performance index;
performing offer model trimming based on the calculated performance index; and
modeling the performance of digital ads and/or keywords based on the calculated performance index.

8. The method of claim 1, wherein the performance index is calculated with respect to a geographic area.

9. The method of claim 1, wherein the performance index is calculated with respect to a behavioral category.

10. The method of claim 1, wherein the performance index is calculated with respect to a demographic category.

11. A computer-readable storage medium comprising a set of instructions for utilizing a performance index measuring a performance of an object as defined by an advertiser, the set of instructions to direct a processor to perform acts of:
receiving one or more values associated with events that result from marketing activities associated with one or more objects;
calculating a performance index associated with an object of the one or more objects, the performance index measuring a performance of the object based on the received one or more values; and
optimizing a digital ad based on the calculated performance index.

12. The computer-readable storage medium of claim 11, wherein receiving one or more values comprises:
receiving values for at least one of impressions, click-throughs, conversions, or revenue associated with conversions.

13. The computer-readable storage medium of claim 11, wherein the object comprises one of a digital ad, an ad group, an ad campaign, and a keyword.

14. The computer-readable storage medium of claim 11, wherein optimizing the digital ad based on the calculated performance index comprises at least one of:
generating a media plan associated with the digital ad based on the calculated performance index;
modifying a media plan associated with the digital ad based on the calculated performance index;
assigning a weight associated with the digital ad based on the calculated performance index; and
modifying a weight associated with the digital ad based on the calculated performance index.

15. A system for utilizing a performance index measuring a performance of an object as defined by an advertiser, the system comprising:
an ad campaign optimizer operative to:
receive one or more values associated with events that result from marketing activities associated with one or more objects;
calcule a performance index associated with an object of the one or more objects, the performance index measuring a performance of the object based on the received one or more values; and
optimize a digital ad based on the calculated performance index.

16. The system of claim 15, wherein the received values comprise at least one of impressions, click-throughs, conversions, or revenue associated with conversions.

17. The system of claim 15, wherein the object comprises one of a digital ad, an ad group, an ad campaign, and a keyword.

18. The system of claim 15, wherein to optimize the digital ad, the ad campaign optimizer is operative to perform at least one of:
generate a media plan associated with the digital ad based on the calculated performance index;
modify a media plan associated with the digital ad based on the calculated performance index;
assign a weight associated with the digital ad based on the calculated performance index; and
modify a weight associated with the digital ad based on the calculated performance index.

19. A method for utilizing a performance index measuring a performance of an object as defined by an advertiser, the method comprising:
receiving one or more values associated with events that result from marketing activities associated with one or more objects;
calculating a performance index associated with an object of the one or more objects, the performance index measuring a performance of the object based on the received one or more values;
generating a report identifying the calculated performance index associated with the object; and
providing the generated report to an advertiser via at least one of a graphical user interface and an application program interface.

20. A computer-readable storage medium comprising a set of instructions for utilizing a performance index measuring a performance of an object as defined by an advertiser, the set of instructions to direct a processor to perform acts of:
receiving one or more values associated with events that result from marketing activities associated with one or more objects;
calculating a performance index associated with an object of the one or more objects, the performance index measuring a performance of the object based on the received one or more values;
generating a report identifying the calculated performance index associated with the object; and
providing the generated report to an advertiser via at least one of a graphical user interface and an application program interface.
